(19) United States
(12) Patent Application Publication
(10) Pub. No.: US 2025/0378481 A1
(43) Pub. Date: Dec. 11, 2025

(54) System and Method for Automatically Matching Product Data

(71) Applicant: Chewy, Inc., Plantation, FL (US)

(72) Inventors: Nakkeeran Annamalai, Johns Creek, GA (US); Yuhui Qian, Lexington, MA (US); Matthew Joseph Hornung, Plymouth, MN (US); Anis Raja Mohamed Ali Jinnah, Hopkinton, MA (US); Srikanth Bulusu, Saratoga, CA (US)

(73) Assignee: Chewy, Inc., Plantation, FL (US)

(21) Appl. No.: 19/226,924

(22) Filed: Jun. 3, 2025

Related U.S. Application Data
(60) Provisional application No. 63/656,335, filed on Jun. 5, 2024.

(51) Int. Cl. G06Q 30/0601; G06F 16/951

(52) U.S. Cl. CPC G06Q 30/0641; G06F 16/951

(57) ABSTRACT

A method of automatically matching target product data to reference product data, the method includes, via a server system, retrieve target product data for a target product that includes target product price and interaction data. The interaction data corresponds to a number of interactions with a rendering of the target product at a target user interface (UI). A web-scraping frequency is determined based on the interaction data. Web-scraping of a reference UI is executed to retrieve reference product data corresponding to a reference product according to the web-scraping frequency. The reference product data includes a reference product price. The target product data is matched to the reference product data. The target product is automatically rendered with the new target product price at the target UI.

### CROSS-REFERENCE TO RELATED APPLICATIONS

This application claims the benefit of U.S. Provisional Patent Application No. 63/656,335 filed Jun. 5, 2024 entitled “System and Method for Automatically Matching Product Data”, which is incorporated by reference herein in its entirety.

### TECHNICAL FIELD

The present disclosure generally relates to systems and methods for matching product data in a database and, in some embodiments, automatically matching target product data based on reference product data and a predefined set of rules.

### SUMMARY

In one embodiment there is a method of automatically matching target product data to reference product data, the method including, at a server system including one or more processers in communication with a database, retrieving target product data corresponding to a target product including target product price and interaction data corresponding to a number of interactions with a rendering of the target product at a target user interface (UI), determining a web-scraping frequency based on the interaction data, executing web-scraping of a reference UI to retrieve reference product data corresponding to a reference product based on the web-scraping frequency, the reference product data including a reference product price, matching the target product data to the reference product data meeting predefined criteria by updating the target product price a new target product price equal to the reference product price, and automatically rendering the target product with the new target product price at the target UI.

In some embodiments, the interaction data includes: i) a number of selections of the rendered target product at the target UI and ii) a number of requests to purchase the rendered target product received at the target UI. In some embodiments, the method further includes at the server system, preventing the new target product price from being updated for a predetermined amount of time. In some embodiments, the method further includes, at the server system retrieving the target product data for a plurality of different target products, determining web-scraping frequencies for each target product of the plurality of target products based on the corresponding target product data, and for each target product of the plurality of target products executing web-scraping of the reference UI to retrieve reference product data for reference corresponding to the target product based on the web-scraping frequency, the reference product data including a reference product price, determining that the reference product price is less than the target product price, updating the target product data to generate a new target product price equal to the reference product price, and automatically rendering the target product with the new target product price at the target UI.

In some embodiments, executing web-scraping of the reference UI to retrieve reference product data includes web-scraping a plurality of reference UIs to retrieve a plurality of reference product data and the method further includes updating the target product data to generate the new target product price equal to one of a reference product price corresponding to one of the plurality of retrieved reference product data meeting the predefined criteria. In some embodiments, updating the target product data includes determining at least one of: i) the lowest reference product price included in the plurality of reference product data meeting the predefined criteria, and ii) a hierarchical ranking of the plurality of reference UIs.

In another embodiment there is a system for automatically matching target product data to reference product data, the system including, a server system including one or more processers in communication with a database, the server system configured to retrieve target product data corresponding to a target product including target product price and interaction data corresponding to a number of interactions with a rendering of the target product at a target user interface (UI), determine a web-scraping frequency based on the interaction data, execute web-scraping of a reference UI to retrieve reference product data corresponding to a reference product based on the web-scraping frequency, the reference product data including a reference product price, match the target product data to the reference product data meeting predefined criteria by updating the target product price a new target product price equal to the reference product price, and automatically render the target product with the new target product price at the target UI.

In some embodiments, the interaction data includes: i) a number of selections of the rendered target product at the target UI and ii) a number of requests to purchase the rendered target product received at the target UI. In some embodiments, the server system is further configured to prevent the new target product price from being updated for a predetermined amount of time. In some embodiments, the server system is further configured to retrieve the target product data for a plurality of different target products, determine web-scraping frequencies for each target product of the plurality of target products based on the corresponding target product data, and for each target product of the plurality of target products, execute web-scraping of the reference UI to retrieve reference product data for reference corresponding to the target product based on the web-scraping frequency, the reference product data including a reference product price, determine that the reference product price is less than the target product price, update the target product data to generate a new target product price equal to the reference product price, and automatically render the target product with the new target product price at the target UI.

In some embodiments, the server system is further configured to web-scrape a plurality of reference UIs to retrieve a plurality of reference product data and update the target product data to generate the new target product price equal to one of a reference product price corresponding to one of the plurality of retrieved reference product data meeting the predefined criteria. In some embodiments, the server system is further configured to determine at least one of: i) the lowest reference product price included in the plurality of reference product data meeting the predefined criteria, and ii) a hierarchical ranking of the plurality of reference UIs when updating the target product data.

### BRIEF DESCRIPTION OF THE DRAWINGS

The following detailed description of embodiments of the system and method for matching product data, will be better understood when read in conjunction with the appended drawings of an exemplary embodiment. It should be understood, however, that the invention is not limited to the precise arrangements and instrumentalities shown.

In the drawings:

FIG. 1 is a block diagram illustrating a system for matching product data in accordance with an exemplary embodiment of the present disclosure;

FIG. 2 is a flowchart illustrating the matching of target product data to reference product data via the system of FIG. 1; and

FIG. 3 is a flowchart illustrating a method for automatically matching target product data to reference product data in accordance with an exemplary embodiment of the present disclosure.

### DETAILED DESCRIPTION

In some embodiments, target products offered for sale via an online storefront may have competing products offered for sale at competing online storefronts. For example, target products may be commoditized products that are offered for sale at a plurality of different storefronts, online or brick and mortar. The target product may be rendered at a target UI displayable at computing devices with an offer for sale price. Potential consumers may access the target UI and view the target product and request to purchase the target product for the displayed sale price, also referred to as a target product price. However, there may be a plurality of reference products that are similar to the target product (e.g., a competing product) and that are offered for sale at different online storefronts at different prices. For example, competing products rendered at a competing online storefront (e.g., a competing UI) may be offered for sale at a lower price than the target product. In such an instance, potential consumers of the target product are more likely to purchase the competing product rather than the target product. Therefore, it may be beneficial to adjust the price of the target product according to the reference competing product such that potential consumers are not incentivized to purchase from a competitor.

However, adjusting the price of a target product to match the price of a reference competing product becomes increasingly difficult using conventional systems and methods as the number of target products and/or competing products increases. The number of target products offered for sale at the target UI may be in the hundreds, thousands, tens of thousands, or millions. Each target product may have a corresponding competing product offered for sale at one or a plurality of different competing online storefronts. For example, a product X may be offered for sale at hundreds of different online storefronts some of which offer the product for sale at different prices and/or with different promotional offers. Because of the nature of online storefronts, the prices of products offered for sale thereon can be changed almost immediately and promotional offers can be introduced or removed just as quickly. For at least the above reasons, monitoring competing product data (e.g., prices, promotional offers) and matching the target product data thereto (e.g., target product price, target product promotional offers) is difficult and time consuming using conventional systems and methods known to those skilled in the art. Furthermore, potential updates to the price of a target product to match a reference product may not fall within the scope of predefined criteria set forth by the retailer of the target product. For example, the retailer may wish to maintain a certain sales margin or already be offering the target product as part of an existing promotion. Therefore, there is a need to provide a system and method for automatically updating target product data based on competing product data and in accordance with a set of predefined criteria.

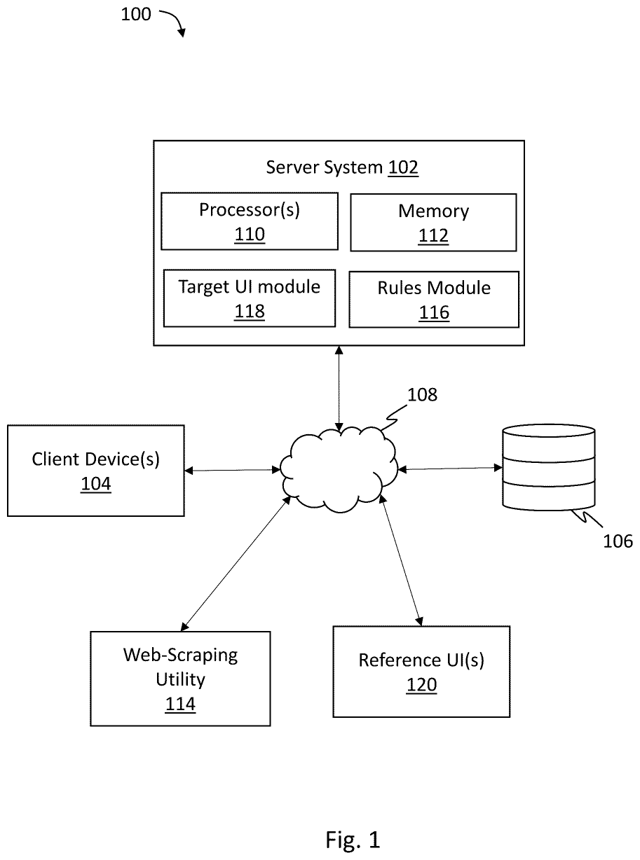

Referring to the drawings in detail, wherein like reference numerals indicate like elements throughout, there is shown in FIG. 1 a system for automatically updating target product data based on reference product data and referred to as system 100 herein, in accordance with an exemplary embodiment of the present invention. The system 100 may be configured to automatically execute web-scraping of a plurality of different online storefronts and generate reference product data therefrom. In some embodiments, the system 100 is configured to, for each reference product and/or reference online retail storefront, automatically determine a web-scraping frequency based on a digital record of interactions and/or transactions with the corresponding target product at the target online storefront. In some embodiments, the system 100 is configured to automatically update a target product price based on a reference product price in response to the reference product price meeting one or more predefined criteria (e.g., pricing criteria).

In one embodiment, the system 100 includes one or more computing devices, having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

There is shown in FIG. 1 a block diagram illustrating an implementation of the system 100. While some example features are illustrated, various other features have not been illustrated for the sake of brevity and so as not to obscure pertinent aspects of the example embodiments disclosed herein. In some embodiments, the system 100 includes one or more computing devices (e.g., server system 102, client device(s) 104, database 106) communicatively coupled to a network 108. The server system 102 may include one or more processors 110 and a memory 112. The memory 112 may be a non-transitory computer readable storage medium. The server system 102 may be configured to execute computer readable code associated with performing the methods discussed herein, which may be stored in memory 112. For example, the server system 102 may include a rules module 116 and/or a target UI module 118, each of which may be executed by the processor(s) 110 to perform the corresponding functionalities discussed in more detail below. In some embodiments, the system 100 includes a web-scraping utility 114 in communication with the server system 102 via the network 108 and configured to execute web-scraping of one or more online storefronts to retrieve reference product data.

Network 108 may include individual connections via the Internet, such as cellular or Wi-Fi networks. In some embodiments, network 108 may connect terminals, services, computing devices, external devices using direct connections, such as, radio frequency identification (RFID), near-field communications (NFC), Bluetooth™, low-energy Bluetooth™ (BLE), Wi-Fi™, Zigbee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security. Network 108 may include computer networking arrangement used to exchange data. For example, network 108 may be representative of the Internet, a private data network, virtual private network using a public network and/or other suitable connection(s) that enables components in system 100 to send and receive information between the components of system 100.

The system 100 may include one or more client devices 104 communicatively coupled to the server system 102 and/or database 106 via network 108. A client device 104 may include computing device such as laptop computers, smart phones, tablets, desktop computers, gaming consoles or other types of personal computing device. The client devices 104 may be representative of computing devices operated by user's interacting with an online storefront. For example, users may operate a client device 104 to access a target UI generated by the target UI module 118 of the server system 102 and/or a reference UI 120. The target UI and reference UIs 120 may each correspond to online storefronts also referred to as an E-commerce storefronts or virtual storefronts. For example, the target UI may be a first online storefront and the reference UIs 120 may be online storefronts other than the first online storefront. An online storefront as referenced herein may include a software application, a website, and/or a mobile application (e.g., a smartphone software application) configured to facilitate the electronic buying and/or selling of products and/or services over the Internet. In some embodiments, the system 100 is configured to automatically match product data for a product rendered at the target UI to the same or similar products rendered at the reference UIs 120.

The server system 102 is configured to update the product data for products offered for sale at an online storefront based on the product data from the same or a substantially similar product offered for sale at another online storefront. Target products, as referenced herein, may include products for which updates to the corresponding target product data are to be made. For example, target products may be the products available at the target UI, which are to be updated based on reference product data. Reference products may include products that are the same as or substantially similar to the target product and are available at (e.g., rendered at) a reference UI 120. For example, for a target product X, the reference products may include the same product X and/or a substantially similar product Y offered for sale at a competing online storefront (e.g., a competing product). Reference products may also include corresponding reference product data for which updates to the target product data are to be based on, as discussed in more detail below.

In some embodiments, the server system 102 may be associated with a target online storefront, mobile software application, or another website or digital space at which the electronic buying and/or selling of target products occurs. The server system 102 is configured to render the target online storefront as a target UI via the target UI module 118. For example, the server system 102 is configured to cause client device(s) 104 to display a target UI including renderings of a plurality of target products offered for sale. Each target product rendered at the target UI may include a corresponding display of a target product data such as: the target product name, one or more digital images of the product, target product quantity, target product description, target product availability, and/or target product price. For example, a rendering of a target product named ‘ABC cat litter’ includes a digital image of the product, displayed text indicating that the price of the product is $25.99, the product is in stock, and that the target product is a non-clumping cat litter.

For each target product offered for sale at the target UI, the corresponding target product data may be stored on the database 106. In some embodiments, the database 106 is in communication with the server system 102 via the network 108. In some embodiments, the database 106 is a relational database. In other embodiments, the database 106 is a non-relational database 106. In some embodiments, the database 106 includes a plurality of networked databases each in communication with the network 108, server system 102 and/or one another. In some embodiments, the database 106 stores data other than the target product data, such as, for example, user profile/account data and pet profile/account data. However, for sake of brevity, only the target product data will be described herein. The server system 102 may be configured to retrieve target product data stored on the database 106 and update the target product data. For example, the server system 102 is configured to communicate with the database 106 to retrieve, delete, add, and/or update the target product data stored thereon.

In some embodiments, the target product data stored in the database 106 includes a record of interactions (e.g., user interactions) with a target product rendered at the online storefront. Interactions with a target product rendered at the online storefront (e.g., target UI) may include, but is not limited to, selecting, clicking, hovering, viewing and/or purchasing the target product via the online storefront. For each target product rendered at the target UI, the rendered target product may be interacted with via client devices 104 in a plurality of different manners and/or times. For example, a rendered target product may be interacted with via one or more of: a selection of the target product details (e.g., a selection to view the target product), a purchase request for the target product, placement of the target product in an online shopping cart/bag, and/or search requests for the target product. The server system 102 is configured to receive an indication of each of the above listed interactions with target products as target product interaction data. For example, in response to a purchase request for a target product X at the target UI, the server system 102 receives target product interaction data indicating the purchase request.

The server system 102 may be configured to update a digital record stored in the database 106 relating to product interactions in response to receiving the target product interaction data. For example, in response to receiving the target product interaction data discussed in the example above, the server system 102 is configured to update the digital record of target product interactions for the target product X stored on the database 106 accordingly. The server system 102 may be configured to repeat the process of receiving interaction data for target products and causing the corresponding digital record to be updated for each, or at least a subset of, the target products having target product data stored on the database 106. For example, the server system 102 is configured to receive interaction data for each interaction with rendered target products at the target UI and cause the corresponding digital record stored in the database 106 to be updated accordingly.

In some embodiments, the server system 102 is configured to receive interaction data with time specific data and update the corresponding digital record accordingly. For example, the time at which the purchase request for the target product X, from the above example, was received at the server system 102 is included in the target product interaction data. The server system 102 may be configured to retrieve target product interaction data according to the time specific data included therewith. For example, the server system 102 may be configured to retrieve all interaction data indicating purchase requests within the last two weeks. In some embodiments, the server system 102 may be configured to compare interaction data for a plurality of different products to determine a most viewed and/or most purchased product over a given period of time (e.g., a week, a month). In some embodiments, the server system 102 is configured to update the digital record of a most viewed and/or most purchased product to reflect the same. In some embodiments, the server system 102 is configured to determine if a product is included in an existing promotional offer and update the digital record to reflect the same.

In some embodiments, the server system 102 is configured to determine a web-scraping frequency at which to execute web-scraping for product data corresponding to products the same as, or substantially similar to target products. For each target product, the server system 102 is configured to determine the web-scraping frequency based on the corresponding target product data stored in the database 106. In some embodiments, the server system 102 determines a web-scraping frequency based on the interaction data associated with a target product. For example, for a target product X, the associated interaction data may include an indication that the target product X was requested for purchase 5,000 times over the past two weeks and was selected to display details thereof 9,000 times within the same two weeks. Based on the interaction data for the target product X, the server system determines that web-scraping for reference product data corresponding to that target product occurs at a frequency of once every 10 minutes (e.g., executing web-scraping once every 10 minutes).

In some embodiments, the server system 102 is configured to determine a web-scraping frequency for a target product based on a comparison of the corresponding target product data to that of other target products. In some embodiments, the server system 102 is configured to automatically assign target products to a tier/level within a hierarchical structure based on the corresponding target product data. For example, the server system 102 is configured to determine a number (e.g., 100, 500, 1000, 5000, 10000) of top selling target products and assign them to the top tier of the hierarchy, and so on for any number of products and any number of predetermined hierarchical tiers/levels. Each tier/level within the hierarchical structure may have an associated web-scraping frequency. For example, the top tier may have a web-scraping frequency of every 5 minutes while the next highest tier has a frequency of every 10 minutes. The server system 102 may be configured to assign target products to a tier within the hierarchical structure and determine the web-scraping frequency to be that which corresponds to the assigned tier. For example, the server system 102 assigns target product A to tier 0 which has a web-scraping frequency of 5 minutes and automatically determines the web-scraping frequency for target product A is every 5 minutes. In some embodiments, the server system 102 is configured to determine the web-scraping frequency based at least partially on the reference UI 120 at which web-scraping is to be executed. The server system 102 in some instances executes web-scraping at two or more reference UIs 120 for a target product. For example, for the target product X, the server system 102 executes web-scraping at a first reference UI 120 associated with a first competitor's online storefront and at a second reference UI 120 associated with a second competitor's online storefront. In some embodiments, the server system 102 determines the web-scraping frequency for a reference UI based on a predetermined hierarchy and/or classification of reference UIs. The database 106 may store classification data for a reference UI associated with a particular competitor. The server system 102 may be configured to execute web-scraping at a frequency at least partially dependent upon the classification data. For example, classification data for two reference UIs may indicate that the first reference UI has a higher classification than the second reference UI. In this example, the server system 102 is configured to execute web-scraping on the first reference UI at a higher frequency than that executed on the second.

The database 106 may include reference UI data associated with a plurality of online storefronts other than the online storefront at which the target product is rendered. The reference UI data may include the web-address for the online storefront (e.g., a website domain, universal resource locator, hypertext transfer protocol secure (HTTPS), hypertext transfer protocol) and a predetermined hierarchical ranking value. For example, and continuing from the above example, the first competitor's online storefront may be ranked above the second competitor's online storefront in the predetermined hierarchical ranking stored in the database 106. Based on the hierarchical ranking, the server system 102 is configured to determine a web-scraping frequency for the reference UIs ranked higher that is greater than web-scraping frequency for reference UIs ranked lower. For example, the server system 102 determines that the web-scraping frequency for the first reference UI is once every 10 minutes and the web-scraping frequency for the second UI is once every 15 minutes.

In some embodiments, the server system 102 is configured to determine the web-scraping frequency for a target product based on a combination of the interaction data and reference UI hierarchical rankings and/or classifications. For example, for the target product X the server system 102 determines a web-scraping frequency of once every 10 minutes for the first reference UI and a web-scraping frequency of once every 15 minutes for the second reference UI. For another target product Y, the server system 102 determines a web-scraping frequency of once every 12 minutes for the first reference UI and a web-scraping frequency of once every 17 minutes for the second reference UI. In some embodiments, providing a server system 102 configured to determine web-scraping frequencies for different reference UIs based on one or more variables as discussed herein may enable the server system 102 to efficiently process the data generated from the web-scraping and/or reduces the generation of data from hierarchically lower ranked sources.

In some embodiments, the server system 102 is configured to execute web-scraping of a reference UI 120 based on the determined web-scraping frequency. The server system 102 may be configured to determine web-scraping frequencies for a plurality of different target products and/or reference UIs 120 as discussed above and generate a request for web-scraping. The request may include an indication of the target products for which web-scraping is to be executed, and for each target product an indication of the reference UI 120 to be scraped and the associated web-scraping frequency. For example, the request to execute web-scraping for the target product X from the preceding example may include an indication that web-scraping of the first reference UI 120 is to be executed at a frequency of once every 10 minutes. In some embodiment, the request for web-scraping includes data pertaining to one or more of: a product unique identifier (e.g., SKU, product number), a competitor product detail page (PDP) web address, scraping frequency, and/or an indication of whether web-scraping is to commence or be ceased.

In some embodiments, server system 102 transmits the request for web-scraping to the web-scraping utility 114 to cause web-scraping of the reference UIs 120. In some embodiments, the web-scraping utility 114 reside on a server or collection of servers including one or more processors configured to execute web-scraping of online storefronts (e.g., reference UIs). In some embodiments, the web-scraping utility 114 is separate from the server system 102 and in communication therewith via the network 108. In other embodiments, the web-scraping utility 114 may be a web-scraping module 114 included in the server system 102. The web-scraping module 114 may include computer executable code that, when executed, web-scrapes websites (e.g., reference UIs 120) to retrieve product data therefrom.

In response to receiving the request for web-scraping from the server system 102, the web-scraping utility 114 executes web-scraping of each reference UI 120 indicated in the request for reference product data corresponding to the target products and based on the corresponding web-scraping frequency. For example, the request for web-scraping of the target product X at the first reference UI 120 at a frequency of once every 10 minute is transmitted to the web-scraping utility 114 by the server system 102. The web-scraping utility accesses the first reference UI via the Internet and executes web-scraping of the reference product that is the same as or substantially similar to the target product X once every 10 minutes.

The web-scraping utility 114 may be configured to generate reference product data in response to executing the web-scraping. The reference product data may include an offer for sale price of the reference product (e.g., a reference product price). For example, web-scraping executed at the web-scraping utility 114 for a reference product corresponding to the target product ‘ABC cat litter’ may result in the web-scraping utility 114 identifying a reference product ‘ABC cat litter’ offered for sale at a competing online storefront (e.g., a reference UI 120). The web-scraping utility 114 generates reference product data for the reference product ‘ABC cat litter’ including an offer for sale price of $13.99. The web-scraping utility 114 is configured to repeat this process according to the web-scraping frequency and generate reference product data accordingly. For example, every 10 minutes the web-scraping utility 114 generates the reference product data for the reference product ‘ABC cat litter’.

In some embodiments, the reference product data may include an indication of promotional offers associated with a reference product. For example, the reference product ‘ABC cat litter’ may be offered as part of an existing promotion in which a purchase of two or more of the product ‘ABC cat litter’ causes the sale price to be reduced by 10% (e.g., a buy two get 10% off promotion). The web-scraping utility 114 is configured to identify the promotional offer and generate corresponding promotional offer data. The web-scraping utility 114 generates the reference product data including the reference product price data and the promotional offer data.

In some embodiments, the web-scraping utility 114 is configured to continuously generate and transmit reference product data based on the determined web-scraping frequency. For example, every 10 minutes the web-scraping utility generates reference product data for the reference product ‘ABC cat litter’ and transmits the generated reference product data to the server system 102. In some embodiments, the server system 102 is configured to cause the web-scraping utility 114 to cease web-scraping. For example, the server system 102 may be configured to receive a request to cease web-scraping and transmit the request to the web-scraping utility 114. In response to receiving the request to cease web-scraping, the web-scraping utility 114 ceases generating reference product data. In some embodiments, the request to cease web-scraping is specific to a reference UI and/or a target product. For example, the server system 102 receives a request to cease web-scraping for only the target product X and causes the web-scraping utility to cease generating reference product data corresponding to the target product X. In some embodiments, the server system 102 is configured to automatically generate the request to cease web-scraping in response to one or more triggers. The one or more triggers may include, but are not limited to: an update to a hierarchical classification for a reference UI, removal of a reference product from a reference UI, removal of target product from a list of products to find a matching reference product for, and/or updates to target product data.

The server system 102 may be configured to receive reference product data and match target product data thereto based on one or more predefined criteria via the rules module 116. The rules module 116 may be a collection of computer executable code configured to match target product data to reference product data based on one or more predefined criteria. Matching target product data to reference product data may include the adjustment of a target product price to match the price of a reference product. For example, matching a target product price of $15.99 to a reference product having a price of $13.99 may include updating the target product price to a new target product price of $13.99. The predefined criteria may be criteria and/or rules that the server system 102 is configured to apply when matching target product data to reference product data. For example, predefined criteria may include an allowable price band within which a target product may be price matched. Further to this example, an allowable price band for the target product, or a product category to which it belongs, may be within 20% of the existing product price. Still referencing this example, the server system 102 receives a reference product price of $13.99 and compares that reference product price to the target product price of $15.99 and which is within the allowable price band and the server system 102 automatically matches the target product price thereto. Some non-limiting examples of predefined criteria may include: an acceptable sales margin, existing promotional offers, product inventories and/or price elasticity.

In some embodiments, the predefined criteria may be criteria that applies to all target products, a subset of target products and/or criteria that is specific to a particular target product. For example, a predefined criteria that applies to all target products offered for sale at the target UI may be that the price of target products may not be updated by the server system 102 to be 20% of the current offer for sale price. A predefined criteria that applies to a subset of target products may be a criterial indicating that for all target products that have a product inventory of zero, no price change may be caused by the server system 102. A predefined criteria that applies to a specific target product may be that for the target product ‘ABC cat litter’ the sales margin must be greater than $2.00.

The server system 102 is configured to apply the predefined criteria when matching target product data to the retrieved reference product data. For example, the server system 102 receives reference product data corresponding to a target product X having target product data indicating a target product price of $23.99 and an existing sales margin of $3.00. The reference product data includes an indication that the reference product price is $17.99. The predefined criteria with which the server system 102 matches target and reference product data includes a first criteria that no price decreases of over 80% for a target product is allowed and a second criteria that for the target product X the lowest acceptable sales margin is $2.00. The server system 102 compares the reference product price of $17.99 to the target product price of $23.99 based on the first criteria and determines that an adjust of the target product price to $17.99 meets the first criteria. The server system 102 compares the reference product price to the target product price based on the second criteria and determines that an adjustment of the target product price to $17.99 does not meet the second criteria because the price of $17.99 results in a sales margin less than $2.00. In this example, the server system 102 determines that the first criteria is met while the second criteria is not and prevents the target product data from being matched to the reference product data. However, in an instance where the reference product price was $22.99, the server system 102 would determine that both the first and second criteria are met and cause the target product price to be matched to the reference product price.

In some embodiments, the server system 102 is configured to match target product data to a plurality of reference product data. For example, for the target product X having a target product price of $23.99 there may be a first reference product having a price of $21.99, a second reference product having a price of $20.99 and a third reference product having a price of $16.99. The server system 102 may compare the reference product data for each of the first, second and third reference products to the target product data based on the predefined criteria. In some embodiments, the server system 102 is configured to determine whether to match the target product data to the first, second and third reference product data individually prior to determining which of the three to match to. For example, the server system 102 may determine that both the first and second reference product prices meet the predetermined criteria as outlined in the above example and that the third reference product price does not.

The server system 102 may determine which of the first and second reference product prices to match the target product price to based on one or more of: i) the lowest reference product price; and ii) the predetermined hierarchical position of the reference UI from which the first and second reference product data was each obtained from. For example, in an instance where the server system 102 matches the target product price to the lowest of the two reference product prices, the server system 102 causes the target product price to be updated to be $20.99. Further to this example, in an instance where the first reference UI is ranked higher than the second reference UI, the server system 102 causes the target product price to be updated to be $21.99.

In some embodiments, the server system 102 is configured to automatically generate a request for manual approval in response to promotional offer data existing for a reference product. For example, reference product data indicating that the reference product ‘ABC cat litter’ is included in a buy two get one free promotion is transmitted to the server system 102. The server system 102 receives the promotional offer data and automatically generates a request for approval to match the corresponding target product data to the reference product data.

In some embodiments, the server system 102 is configured to automatically update the online storefront for target products in response to matching target product data to reference product data. For example, the server system 102 matches the target product data for a target product X to a reference product and updates the target product price of $19.99 to match the reference product price of $17.99. The server system 102 causes the rendering of the target product X displayed at the target UI to be updated such that the new target product price $17.99 is displayed thereon. In some embodiments, the server system 102 is configured to update the target UI in real-time or at a predetermined interval. For example, the server system 102 may be configured to store a record of all updated target product prices and automatically cause the target UI to render to updated target product prices at a specific time of day. Alternatively, the server system 102 may be configured to automatically cause the rendering of a target product to be updated at substantially the same time as when the target product price is updated. In some embodiments, the server system 102 is configured to prevent further matching of a target product data to reference product data for a predetermined amount of time. For example, the server system 102 matches the target product data to reference product data by updating the target product price and prevents a subsequent update of the target product price for a set amount of time (e.g., 24 hours).

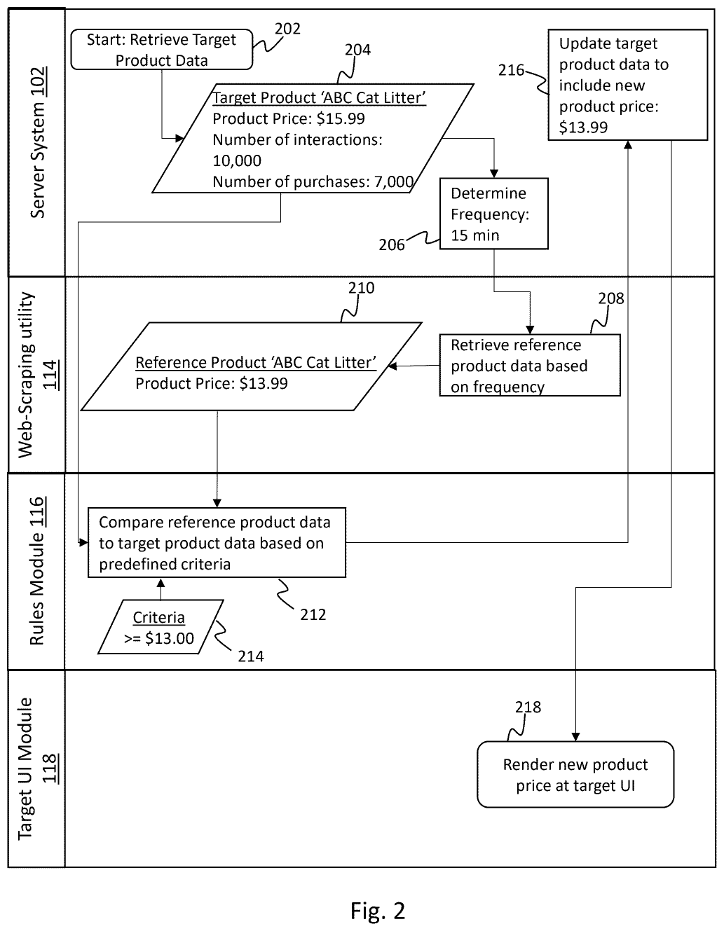

Referring to FIG. 2, there is shown a flowchart illustrating an example of executing a method, generally designated 200, of matching target product data to reference product data via the system 100 of the present disclosure. In FIG. 2, the server system 102 executes the step of retrieving 202 target product data 204 for the target product ‘ABC cat litter’ from the database 106. The target product data 204, in this example, includes the product price of $15.99, and interaction data indicating that the number of interactions with the target product at the target UI is 10,000 and the number of purchases therefrom is 7,000. The server system 102 executes the step 206 of determining the web-scraping frequency, which in this example is once every 15 minutes, based on the target product data 204 indicating that there were 10,000 interactions and 7,000 purchases of the target product. The server system 102 transmits a request to the web-scraping utility 114 to execute web-scraping at the predetermined frequency of once every 15 minutes for a reference product corresponding to the target product.

The web-scraping utility 114 is configured to perform the step 208 of retrieving the reference product data corresponding to the target product based on the frequency determined at step 206. For example, the web-scraping utility 114 executes the web-scraping at the determined web-scraping frequency (e.g., once every 15 minutes) and generates the reference product data 210 for the product ‘ABC cat litter’ available for purchase at the reference UI 120 (e.g., a competing online storefront). The reference product data includes the reference product price of $13.99. The web-scraping utility 114 is configured to transmit the reference product data to the server system 102. Server system 102 is configured to receive reference product data and determine whether match criteria is met. If a match criteria is met, the server system 102 is further configured to instruct the rules module 116 to match the product data. The rules module 116 is configured to execute the step 212 of comparing the reference product data 210 to target product data 204 based on predefined criteria 214 and determine whether to match the target product data 204 to the reference product data 210. For example, the rules module 116 is configured to receive predefined criteria 214 for the target product ‘ABC cat litter’ that the product price thereof may not be below $13.00. Although not shown in FIG. 2, the predefined criteria 214 may include a plurality of different criterion such as, a minimum offer for sale price, an acceptable sales margin, existing promotional offers, product inventories and/or price elasticity as discussed above.

In this example, the rules module 116 compares the product price for the reference product of $13.99 to the predetermined criteria and determines that the reference product price of $13.99 is greater than $13.00 and therefore meets the predetermined criteria. In response to the rules module 116 determining that the reference product price meets the predetermined criteria, the server system 102 is configured to perform the step 216 of updating the target product data 204 stored on the database 106 to include a new product price matching the reference product data 212. For example, the server system 102 transmits a command to the database 106 causing the product price of $15.99 included in the target product data 204 to be updated to be $13.99. The server system 102, via the target UI module 118 is configured to execute the step 218 of rendering the new product price at the target UI. For example, the target UI module 118 causes the rendered target product price of $15.99 to be replaced with a new target product price of $13.99 matching the reference product price at the target UI (e.g., the target online storefront).

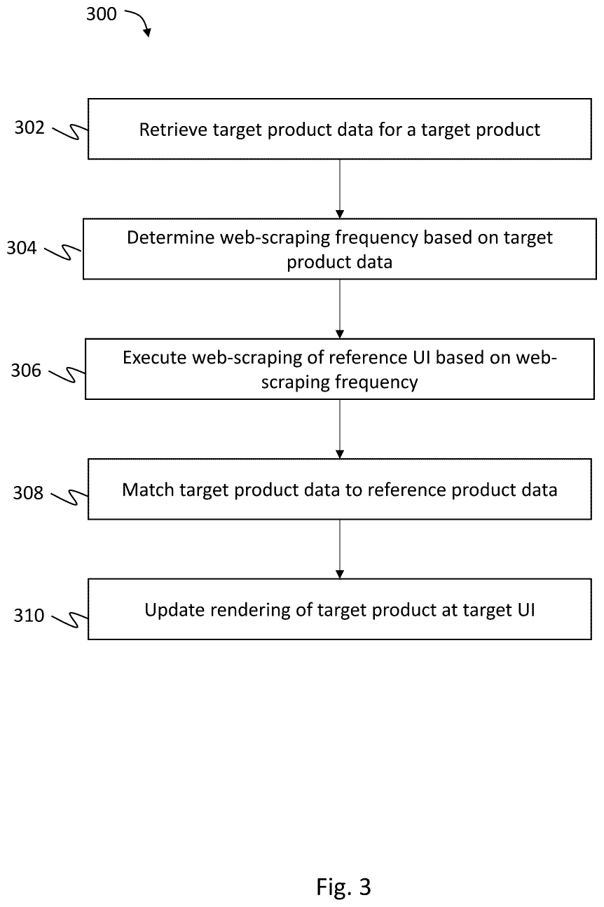

Referring to FIG. 3, there is shown a flowchart illustrating a method of automatically matching target product data to reference product data, generally designated 300 and referred to as method 300, in accordance with an exemplary embodiment of the present disclosure. In some embodiments, the method 300 includes the step 302 of retrieving target product data corresponding to a target product including target product price and interaction data corresponding to a number of interactions with a rendering of the target product at a target UI. For example, the server system 102 is configured to retrieve the target product data from database 106 including the price of the target product and interaction data corresponding to the number of recorded interactions with the rendering of the target product at the target UI as discussed above with reference to FIG. 1. In some embodiments, the interaction data includes: i) a number of selections of the rendered target product at the target UI and ii) a number of requests to purchase the rendered target product received at the target UI. For example, the target product data stored on the database 106 corresponding to a target product includes a digital record of the number of times the rendered target product was selected for display and/or the number of times the target product was requested for purchase via the target UI.

In some embodiments, the method 300 includes the step 304 of determining a web-scraping frequency based on the interaction data. For example, the server system 102 is configured to determine a web-scraping frequency based on the number and/or type of interactions with the corresponding rendered target product at the target UI as discussed above. In some embodiments, the method 300 includes the step 306 of executing web-scraping of a reference UI to retrieve reference product data corresponding to a reference product based on the web-scraping frequency. For example, and as discussed above, the server system 102 transmits a request to the web-scraping utility 114 to execute web-scraping at a reference UI for reference product data at the determined web-scraping frequency. The reference product data may include a reference product price. For example, the server system 102 is configured to cause the web-scraping utility to retrieve reference product data for a reference product that is the same as, or substantially similar to the target product and the retrieved reference product data includes the price at which the reference product is offered for sale.

In some embodiments, the method 300 includes executing web-scraping of the reference UI to retrieve reference product data includes web-scraping a plurality of reference UIs to retrieve a plurality of reference product data. For example, the server system 102 is configured to cause the web-scraping utility 114 to execute web-scraping for a first reference UI and a second reference UI to retrieve first and second reference product data. The method 300 may further include updating the target product data to generate the new target product price equal to one of a reference product price corresponding to one of the plurality of retrieved reference product data meeting the predefined criteria. For example, and as discussed above, the rules module 116 is configured to determine whether the first and second reference product meet the predetermined criteria. The server system 102 generates the new target product price based on the determination from the rules module 116 and based on one or more factors such as: i) the lowest reference product price meeting the predetermined criteria; and ii) a hierarchical ranking of the plurality of reference UIs. For example, in an instance where both reference product prices meet the predetermined criteria and the first reference product price is less than the second reference product price the server system 102 causes the target product price to be updated to match the first product reference product price.

The method 300 may include the step 308 of matching the target product data to the reference product data meeting predefined criteria by updating the target product price a new target product price equal to the reference product price. For example, and as discussed above, in response to determining that the predefined criteria is met via the rules module 116, the server system 102 causes the target product data to match the reference product data by replacing the corresponding target product price stored in the database 106 with the reference product price. In some embodiments, the method includes preventing the new target product price from being updated for a predetermined amount of time. For example, in response to matching a target product price to a reference target product price, the server system 102 is configured to prevent subsequent updates to the target product price for a predetermined amount of time (e.g., 24 hours). In some embodiments, the method 300 includes the step 310 of automatically rendering the target product with the new target product price at the target UI. For example, and as discussed above, the server system 102 causes the target UI to render the target product including a display of the new target product price.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A method of automatically matching target product data to reference product data, the method comprising:
at a server system including one or more processers in communication with a database:
retrieving target product data corresponding to a target product including target product price and interaction data corresponding to a number of interactions with a rendering of the target product at a target user interface (UI);
determining a web-scraping frequency based on the interaction data;
executing web-scraping of a reference UI to retrieve reference product data corresponding to a reference product based on the web-scraping frequency, the reference product data including a reference product price;
matching the target product data to the reference product data meeting predefined criteria by updating the target product price a new target product price equal to the reference product price; and
automatically rendering the target product with the new target product price at the target UI.

2. The method of claim 1, wherein the interaction data includes: i) a number of selections of the rendered target product at the target UI and ii) a number of requests to purchase the rendered target product received at the target UI.

3. The method of claim 1 further comprising:
at the server system, preventing the new target product price from being updated for a predetermined amount of time.

4. The method of claim 1 further comprising:
at the server system:
retrieving the target product data for a plurality of different target products;
determining web-scraping frequencies for each target product of the plurality of target products based on the corresponding target product data; and
for each target product of the plurality of target products:
executing web-scraping of the reference UI to retrieve reference product data for reference corresponding to the target product based on the web-scraping frequency, the reference product data including a reference product price;
determining that the reference product price is less than the target product price;
updating the target product data to generate a new target product price equal to the reference product price; and
automatically rendering the target product with the new target product price at the target UI.

5. The method of claim 1, wherein executing web-scraping of the reference UI to retrieve reference product data includes web-scraping a plurality of reference UIs to retrieve a plurality of reference product data and the method further includes:
updating the target product data to generate the new target product price equal to one of a reference product price corresponding to one of the plurality of retrieved reference product data meeting the predefined criteria.

6. The method of claim 5, wherein updating the target product data includes determining at least one of: i) the lowest reference product price included in the plurality of reference product data meeting the predefined criteria, and ii) a hierarchical ranking of the plurality of reference UIs.

7. A system for automatically matching target product data to reference product data, the system comprising:
a server system including one or more processers in communication with a database, the server system configured to:
retrieve target product data corresponding to a target product including target product price and interaction data corresponding to a number of interactions with a rendering of the target product at a target user interface (UI);
determine a web-scraping frequency based on the interaction data;
execute web-scraping of a reference UI to retrieve reference product data corresponding to a reference product based on the web-scraping frequency, the reference product data including a reference product price;
match the target product data to the reference product data meeting predefined criteria by updating the target product price a new target product price equal to the reference product price; and
automatically render the target product with the new target product price at the target UI.

8. The system of claim 7, wherein the interaction data includes: i) a number of selections of the rendered target product at the target UI and ii) a number of requests to purchase the rendered target product received at the target UI.

9. The system of claim 7, wherein the server system is further configured to prevent the new target product price from being updated for a predetermined amount of time.

10. The system of claim 7, wherein the server system is further configured to:
retrieve the target product data for a plurality of different target products;
determine web-scraping frequencies for each target product of the plurality of target products based on the corresponding target product data; and
for each target product of the plurality of target products:
execute web-scraping of the reference UI to retrieve reference product data for reference corresponding to the target product based on the web-scraping frequency, the reference product data including a reference product price;
determine that the reference product price is less than the target product price;
update the target product data to generate a new target product price equal to the reference product price; and
automatically render the target product with the new target product price at the target UI.

11. The system of claim 10, wherein the server system is further configured to web-scrape a plurality of reference UIs to retrieve a plurality of reference product data and update the target product data to generate the new target product price equal to one of a reference product price corresponding to one of the plurality of retrieved reference product data meeting the predefined criteria.

12. The system of claim 11, wherein the server system is further configured to determine at least one of: i) the lowest reference product price included in the plurality of reference product data meeting the predefined criteria, and ii) a hierarchical ranking of the plurality of reference UIs when updating the target product data.
